(19) United States
(12) Patent Application Publication
(10) Pub. No.: US 2022/0272050 A1
(43) Pub. Date: Aug. 25, 2022

(54) SYSTEMS AND METHODS FOR ALLOCATING RESOURCES TO EXECUTE FUNCTIONS

(71) Applicant: ZEBRA TECHNOLOGIES CORPORATION, Lincolnshire, IL (US)

(72) Inventors: Matthew Louis Kowalski, Merrick, NY (US); Zenon Nestor Evans, Chicago, IL (US); Nathan J. Clevenger, Burnsville, MN (US)

(21) Appl. No.: 17/185,211

(22) Filed: Feb. 25, 2021

(51) Int. Cl. H04L 12/927

(52) U.S. Cl. CPC H04L 47/80

(57) ABSTRACT

A method comprising: storing, at a central server, a function definition including: (i) a trigger event to initiate the function; (ii) criteria to be evaluated; and (iii) a response definition; selecting, at the central server, for each of a plurality of edge devices capable of detecting the trigger event and in communication with the central server, a designated criteria evaluation device assigned to evaluate the criteria when the trigger event is detected at the edge device; selecting, at the central server, for each of the plurality of edge devices capable of detecting the trigger event and in communication with the central server, a designated responding device assigned to generate the response when the criteria are satisfied; and sending instructions to the edge device, the designated criteria evaluation device, and the designated responding device to enable execution of the function when the edge device detects the trigger event.

### BACKGROUND

Facilities may implement workflow functions to perform inspections, identify significant or important items, or other checks and balances to assist with facility operations. These workflow functions may often be implemented on an as-needed basis requiring time-consuming updates to ensure personnel and device programming are up-to-date with the required workflow function processes.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a schematic of a system for allocating resources to execute functions.

FIG. 2 is a block diagram of certain internal hardware components of the server of FIG. 1.

FIG. 3 is a flowchart of a method of allocating resources to execute functions.

FIG. 4 is a flowchart of a method of processing a function.

FIG. 5 is a schematic diagram of an example performance of the method of FIG. 3.

FIG. 6 is a schematic diagram of an example performance of the method of FIG. 4.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a method comprising: storing, at a central server, a function definition including: (i) a trigger event to initiate the function; (ii) criteria to be evaluated; and (iii) a response definition; selecting, at the central server, for each of a plurality of edge devices capable of detecting the trigger function and in communication with the central server, a designated criteria evaluation device assigned to evaluate the criteria when the trigger event is detected at the edge device; and selecting a designated responding device assigned to generate the response when the criteria are satisfied; and sending instructions to the edge device, the designated criteria evaluation device, and the designated responding device to enable execution of the function when the edge device detects the trigger event.

Additional examples disclosed herein are directed to a server comprising: a memory storing a function definition including: (i) a trigger event to initiate the function; (ii) criteria to be evaluated; and (iii) a response definition; and a processor connected with the memory, the processor configured to: select, for each of a plurality of edge devices capable of detecting the trigger event and in communication with the server, a designated criteria evaluation device assigned to evaluate the criteria when the trigger event is detected at the edge device; select, for each of the plurality of edge devices capable of detecting the trigger event and in communication with the server, a designated responding device assigned to generate the response when the criteria are satisfied; and send instructions to the edge device, the designated criteria evaluation device, and the designated responding device to enable execution of the function when the edge device detects the trigger event.

Additional examples disclosed herein are directed to a system comprising: a plurality of edge devices located at a facility; a secondary server; and a central server configured to: store a function definition including: (i) a trigger event to initiate the function; (ii) criteria to be evaluated; and (iii) a response definition; select, for each of the plurality of edge devices capable of detecting the trigger event and in communication with the central server, a designated criteria evaluation device from the plurality of edge devices and the secondary server, the designated criteria evaluation device assigned to evaluate the criteria when the trigger event is detected at the selected edge device; select, for each of the plurality of edge devices capable of detecting the trigger event and in communication with the central server, a designated responding device from the plurality of edge devices and the secondary server, the designated responding assigned to generate the response when the criteria are satisfied; and send instructions to the edge device, the designated criteria evaluation device, and the designated responding device to enable execution of the function when the edge device detects the trigger event.

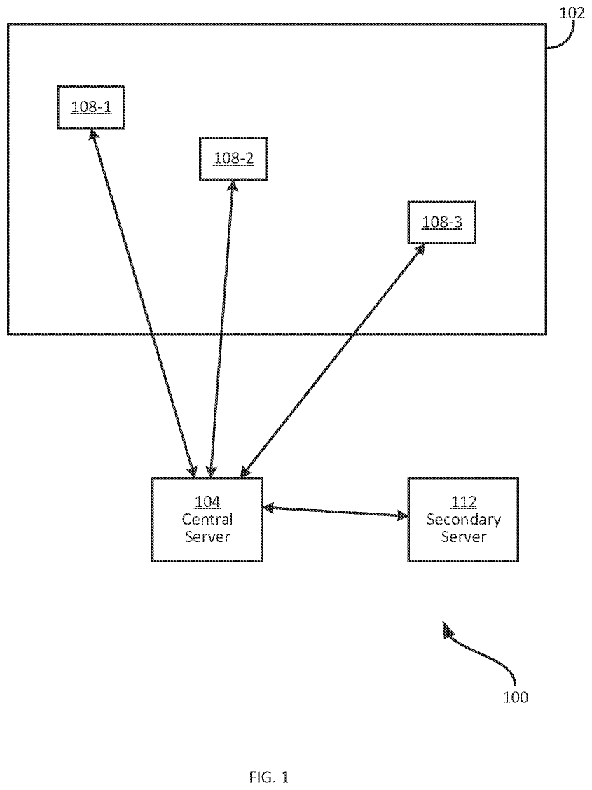

FIG. 1 depicts a system 100 for allocating computational resources to execute workflow functions. The system 100 may be deployed in association with at least one facility 102, such as a retail establishment, warehouse, event space, commercial or government building, or other facility. As will be apparent in the discussion below, the system 100 may also be deployed in a wide variety of other types of facilities. The system 100 includes a central server 104, a plurality of edge devices 108, and a secondary server 112.

Generally, the system 100 allocates computational resources for executing workflow functions. In particular, the central server 104 (also referred to herein as simply the server 104) stores function definitions of workflow functions to be performed relating to facility operations. The function definitions include a trigger which may be detected at an edge device 108, criteria to be evaluated, and a response to be generated based on the results of the criteria evaluation. Based on the computational capabilities of the edge devices, the central server 104 may allocate the criteria evaluation and response generation to different edge devices 108 or to the secondary server 112. In particular, the central server 104 may allocate execution of the different portions of the function to reduce bandwidth load of data streamed out of the facility 102 while managing the computational capacity of the edge devices 108 within the facility 102. The components of the central server 104 will be described in greater detail below.

The edge devices 108, of which three examples, 108-1, 108-2, and 108-3 are depicted (collectively referred to as the edge devices 108 and generically referred to as an edge device 108), are devices which serve as points of entry into enterprise infrastructure or service provider networks employed within the facility 102. The edge devices 108 may be located around the facility 102 and may generally be configured to facilitate operations within the facility 102. The edge devices 108 may include fixed devices such as sensors (e.g., image sensors, cameras, temperature sensors or the like), monitoring devices, barcode scanners, and other suitable devices fixed in the infrastructure of the facility 102. The edge devices 108 may additionally include mobile computing devices such as handheld computers, printers, RFID readers, barcode scanners, tablets, or the like, which may be moved and operated by operators within the facility 102. The edge devices 108 may further include stationary computing devices, such as desktop computers, printers, scanners, or the like deployed within the facility 102.

The edge devices 108 may include devices which may detect different trigger events, such as barcode scans, detection of certain conditions or thresholds by the sensors (e.g., temperature thresholds, detected image patterns, etc.) and the like. Some of the edge devices 108 may also be capable of performing computing functions, such as performing database accesses or lookups, requesting information from remote or online sources, or other comparisons or evaluations of the criteria defined in the function definitions. Further, the edge devices 108 may be capable of generating responses, such as vibrating, generating a visual or audio alert, printing media, or the like. In particular, each of the edge devices 108 may have different capabilities for detecting trigger events, evaluating criteria, and generating responses based on their sensors, communications interfaces, processing and memory resources, input/output devices, and other hardware components. More generally, each of the edge devices 108 may include a runtime agent (e.g., a client application) interfacing with the lower-level device components to identify and interface with the edge device capabilities as well as the server 104 during the resource allocation operation. The edge devices 108 may communicate with the server 104 via one or more wired or wireless connections traversing one or more communications networks, including wide-area networks, such as the Internet.

The system 100 also includes the secondary server 112 in communication with the server 104. The secondary server 112 is generally configured to perform computations and communications including criteria evaluation and generating responses (e.g., sending notifications or the like) during the resource allocation operation. The secondary server 112 may be implemented in any suitable server computing environment, including a cloud-based computing environment.

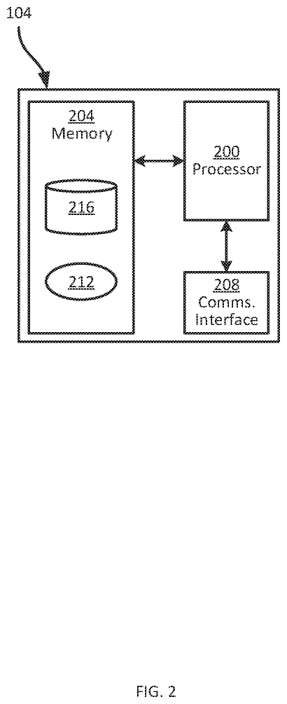

Turning now to FIG. 2, certain internal components of the server 104 are illustrated. The server 104 includes a controller, such as a processor 200, interconnected with a non-transitory computer readable storage medium, such as a memory 204. The memory 204 includes a combination of volatile memory (e.g. Random Access Memory or RAM) and non-volatile memory (e.g. read only memory or ROM, Electrically Erasable Programmable Read Only Memory or EEPROM, flash memory). The processor 200 and the memory 204 each comprise one or more integrated circuits. The server 104 also includes a communications interface 208 enabling the server 104 to exchange data with other devices such as the edge devices 108 and the secondary server 112.

The memory 204 stores computer readable instructions for execution by the processor 200. In particular, the memory 204 stores a resource allocation application 212 which, when executed by the processor 200, configures the processor 200 to allocate portions of various workflow functions amongst the edge devices 108 and the secondary server 112. Those skilled in the art will appreciate that the functionality implemented by the processor 200 via the execution of the application 212 may also be implemented by one or more specially designed hardware and firmware components, such as FPGAs, ASICs and the like in other embodiments.

The memory 204 also stores a repository 216 storing function definitions. In particular, each function definition includes a trigger event which causes the function to be initiated, criteria to be evaluated, and a response definition for responding to the results of the criteria evaluation.

For example, a workflow function to be performed may be to monitor for a product recall. Accordingly, the repository 216 may store a function definition for the product recall having a barcode scan as a trigger event. That is, whenever an edge device 108 scans a barcode, the trigger event of the product recall function is identified. The function definition may further define criteria to check whether the product code encoded into the barcode corresponds to a recalled product. In particular, the function definition may define instructions to evaluate the criteria, including accessing a product recall database and comparing the product code to the product recall database. Finally, the function definition may further include a response definition for responding to the results of the criteria evaluation. For example, if the product code is located in the product recall database, the criteria are satisfied, the response definition may include generation of an alert to notify an operator that the recently scanned product has a recall associated with it. Conversely, if the product code is not located and the criteria is not satisfied, the response definition may indicate that no response is necessary. Alternately, no response definition may be defined if the criteria is not satisfied, resulting in no action being taken.

The communications interface 208 is interconnected with the processor 200. The communications interface 208 includes suitable hardware (e.g., transmitters, receivers, network interface controllers and the like) allowing the server 104 to communicate with other computing devices—particularly the edge devices 108. The specific components of the communications interface 208 are selected based on the type of network or other links that the server 104 communicates over.

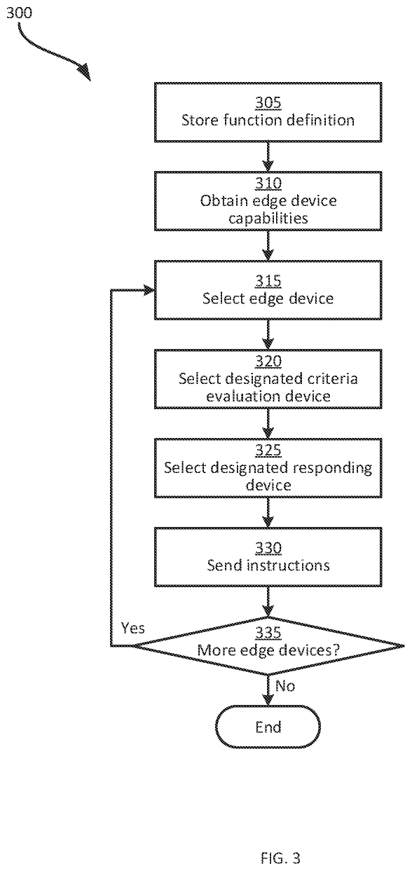

Turning now to FIG. 3, the functionality implemented by the server 104 will be discussed in greater detail. FIG. 3 illustrates a method 300 of allocating computational resources for executing a function. The method 300 will be discussed in conjunction with its performance in the system 100, and particularly by the server 104, via execution of the application 212. In particular, the method 300 will be described with reference to the components of FIGS. 1 and 2. In other examples, the method 300 may be performed by other suitable devices or systems.

The method 300 is initiated at block 305, where the server 104 stores a function definition in the repository 216, including a trigger, criteria, and a response definition for the function. For example, the server 104 may receive a new function definition defining a new function or process to be executed by the system to facilitate a workflow of the facility operations. As a result of receiving the new function definition, the server 104 may allocate resources for efficient processing of the new function.

At block 310, the server 104 obtains the device capabilities of each of the edge devices 108. In some examples, obtaining the device capabilities may include receiving the device capabilities from the edge devices 108 themselves. That is, each edge device 108 may include a runtime agent configured to interface with lower-level application program interfaces (APIs) of the edge device 108 to determine edge device-specific information and capabilities. For example, the runtime agent may determine that an edge device 108 is a barcode scanner capable of detecting barcodes. Additionally, the runtime agent may determine whether the barcode scanner is a mobile barcode scanner having limited computational capacity, or whether it is integrated with a computer (e.g., a checkout counter) having Internet access, or the like. The runtime agent may then relay the determined device capabilities of the edge device 108, together with an edge device identifier for processing and storage at the server 104. The server 104 may then store the device capabilities in association with the edge device identifier in the memory 204. Accordingly, on subsequent iterations of the method 300, the server 104 may simply retrieve the device capabilities from the memory 204 to obtain the device capabilities of each edge device 108.

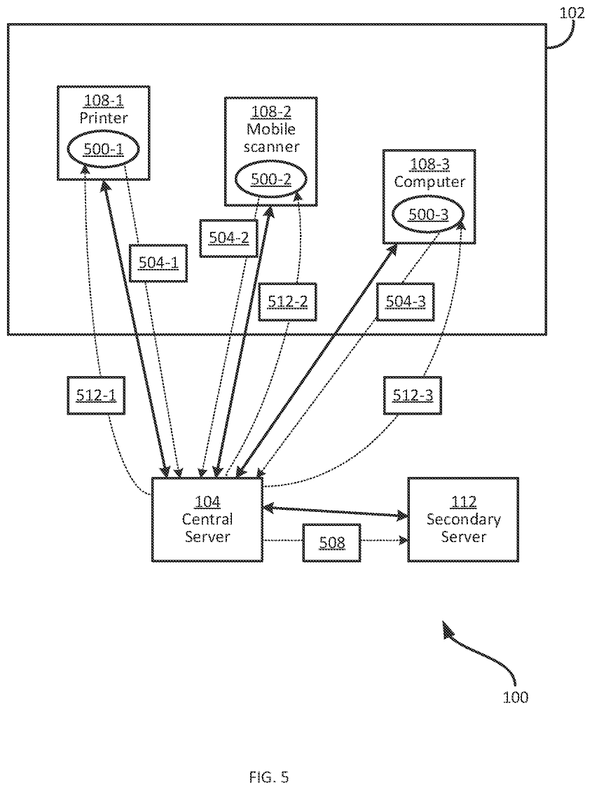

For example, FIG. 5 depicts the edge devices 108-1, 108-2, and 108-3, corresponding to a printer, a mobile barcode scanner, and a computer, respectively, having runtime agents 500-1, 500-2, and 500-3, respectively. At block 325, the printer 108-1, and in particular the runtime agent 500-1 sends device capabilities 504-1 of the printer 108-1 to the central server 104. Similarly, the mobile scanner 108-2, and in particular the runtime agent 500-2 sends device capabilities 504-2 of the mobile scanner 108-2 to the server 104, and the checkout register, and in particular the runtime agent 500-3, sends device capabilities 504-3 of the computer 108-3 to the server 104.

Returning to FIG. 3, at block 315, the server 104 selects an edge device 108 capable of detecting the trigger event for which to allocate resources for the function. That is, the server 104 is configured to determine which computing devices are to perform which portions of the function definition (i.e., evaluation of the criteria, and generating a response) based on the computational complexity and requirements of the portions of the function, as well as the device capabilities of the computing devices. Since more than one edge device 108 may be able to detect the trigger event, and each of the edge devices 108 has different capabilities, the server 104 may iterate through the edge devices 108 to assign a resource allocation of the criteria evaluation and response for each. Accordingly, at block 315, the server 104 may review the device capabilities of each of the edge devices 108 obtained at block 310 and identify edge devices 108 capable of detecting the trigger event. From the edge devices 108 capable of detecting the trigger event, the server 104 selects one.

At block 320, the server 104 selects a designated criteria evaluation device assigned to evaluate the criteria. In particular, the designated criteria evaluation device is assigned to evaluate the criteria for instances of the function execution in which the trigger event is detected at the edge device 108 identified at block 315. The server 104 may select the designated criteria evaluation device from the edge devices 108, including both the edge device 108 which detects the trigger event and further edge devices 108, and the secondary server 112.

In particular, the server 104 selects the designated criteria evaluation device based on the device capabilities of the edge devices 108. To select the designated criteria evaluation device, the server 104 may review the criteria evaluation process and requirements and select an edge device 108 capable of performing the criteria evaluation. For example, if evaluation of the criteria includes accessing an online database, the server 104 may select the designated criteria evaluation device from devices with Internet capabilities to access the online database. If no edge devices 108 are capable of performing the criteria evaluation, the server 104 may select the secondary server 112 as the designated criteria evaluation device.

In particular, the server 104 may preferably select, as the designated criteria evaluation device, the same edge device 108 which detects the trigger event. That is, the edge device 108 may both detect the trigger event and, in response to the trigger event, evaluate the criteria. If the edge device 108 which detects the trigger event is not capable of evaluating the criteria, the server 104 may preferably select, as the designated criteria evaluation device, another one of the edge devices 108 located at the facility 102. That is, the server 104 may prioritize selection of the designated criteria evaluation device to reduce bandwidth load of communications between multiple devices, and particularly the load of outsourcing and streaming the necessary data offsite to the secondary server 112. In some examples, the server 104 may select more than one designated criteria evaluation device for example, for parallel processing. In other examples, other priorities or criteria for selecting the designated criteria evaluation device are contemplated.

For example, referring again to FIG. 5, the server 104 may identify the mobile scanner 108-2 which is capable of scanning a barcode. The server 104 may select, as the designated criteria evaluation device, the secondary server 112 to evaluate criteria to determine whether the scanned barcode corresponds to a high-value or critical package, based on access to an online repository tracking shipments.

At block 325, the server 104 selects a designated responding device assigned to generate a response when the criteria conditions are satisfied. As with the designated criteria evaluation device, the designated responding device is assigned to generate a response for instances of the function in which the criteria conditions are satisfied as a result of the trigger event being detected at the edge device 108 identified at block 315. The server 104 may select the designated responding device from the edge devices 108, including both the edge device 108 which detects the trigger event and further edge devices 108, and the secondary server 112.

The server 104 also selects the designated responding device based on the device capabilities of the edge devices 108. To select the designated responding device, the server 104 may review the response requirements and select an edge device 108 capable of generating the response. For example, if the response includes printing a label to be attached to a scanned product, the server 104 may select an edge device 108 which is identified as a printer, such as the printer 108-1 (depicted in FIG. 5). If the secondary server 112 is capable of generating the response, in some examples, the server 104 may select the secondary server 112 as the designated responding device.

The server 104 may select, as the designated responding device, the same edge device 108 which detects the trigger event or the designated criteria evaluation device selected at block 320. In particular, to reduce the bandwidth load of communications between communications devices, if the designated criteria evaluation device is capable of generating the specified response, the same device may be selected as the designated responding device. In other examples, other criteria for selecting the designated responding device are contemplated. For example, the designated responding device may be selected based on proximity to the edge device 108 detecting the trigger event. For example, if a label is to be printed and attached to a scanned product, the designated responding device may be the printer in closest proximity to the edge device 108 which detected the trigger event for the convenience of an operator to retrieve and attach the label. In some examples, more than one designated responding device may be selected, based on the response definition. For example, in addition to printing the label, the response definition may define that the edge device 108 detecting the trigger event is to vibrate, if it is capable of vibrating, and to display a notification message. Accordingly, the server 104 may select the mobile scanner 108-2 as another designated responding device to vibrate to notify the operator of the criteria being satisfied, and the computer 108-3 as another designated responding device to display the notification message.

At block 330, the server 104 sends instructions to one or more of the edge device 108 selected at block 315 as detecting the trigger event, the designated criteria evaluation device selected at block 320, and the designated responding device selected at block 325. In particular, the instructions, when executed, allow each of the devices to perform their respective portions of the function—that is, detection of the trigger event and processing the trigger event to prompt initiation of the criteria evaluation, and if the criteria evaluation determines that the criteria conditions are satisfied, prompting generation of the response.

In some examples, such as when each of the designated criteria evaluation device and the designated responding device are static, the server 104 may send sets of instructions to each of the devices individually for processing the respective portions of the function. For example, the server 104 may send criteria evaluation instructions 508 to the secondary server 112 to determine whether a scanned barcode corresponds to a high-value or critical package. Additionally, the server 104 may send responding instructions 512-1 to the printer 108-1 to print a label when the scanned barcode corresponds to a high-value or critical package, responding instructions 512-2 to the mobile scanner 108-2 to vibrate when the scanned barcode corresponds to a high-value or critical package, and responding instructions 512-3 to the computer 108-3 to display a notification message when the scanned barcode corresponds to a high-value or critical package.

In other examples, such as when the designated criteria evaluation device and the designated responding device are dynamically selected (e.g., based on proximity when the trigger event is detected, or if the selection is performed in real-time in response to the trigger being detected), the server 104 may encode the criteria evaluation instructions into the trigger event processing instructions sent to the edge device 108 to be propagated to the designated criteria evaluation device upon detection of the trigger event. Similarly, the server 104 may encode the response instructions into the criteria evaluation instructions sent to the designated criteria evaluation device (either by the server 104 or the edge device 108) to be propagated to the designated responding device upon satisfaction of the criteria.

At block 335, the server 104 determines whether there are more edge devices 108 capable of detecting the trigger event, and for which resource allocation for the function has not yet been performed. If such edge devices 108 exist, the server 104 returns to block 315 to select another edge device 108 and assign resources to perform the criteria evaluation and response generation for instances of the trigger event being detected at that edge device 108. Thus, the server 104 selects respective designated criteria evaluation devices and designated responding devices for each further edge device capable of detecting the trigger event of the function. If, at block 335, the server 104 determines that all edge devices 108 capable of detecting the trigger event have had resource allocations assigned when they detect the trigger event, the method 300 ends.

The server 104 may additionally repeat the method 300 for each function definition provided to the server 104. The system 100 thus allows different function definitions, including trigger events, criteria and response definitions, to be stored and allocated for performance amongst the edge devices 108 and the secondary server 112. Advantageously, a system administrator may simply provide the function definition including the instructions for processing the trigger events, criteria and response definitions to the server 104, which may dynamically allocate resources to perform the function amongst the edge devices 108 and the secondary server 112. That is, the process of assigning and programming in instructions to perform the various functions is performed by the server, rather than requiring device-by-device updates from the system administrator.

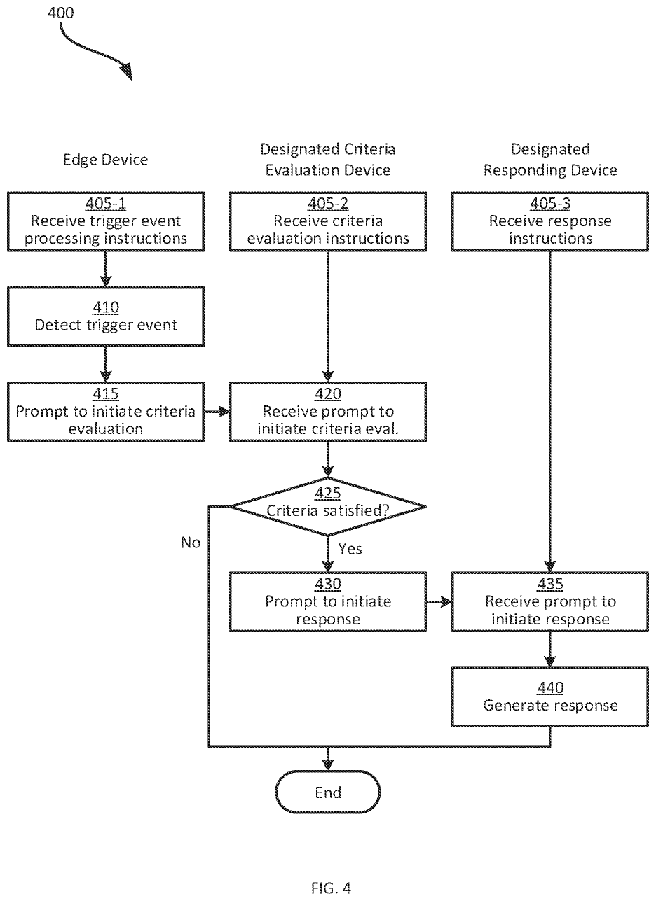

FIG. 4 depicts a method 400 of processing a function after allocation of the resources of the system 100 by the server 104. The method 400 will be described in conjunction with its performance by the edge device 108 which detects a trigger event, the designated criteria evaluation device, and the designated responding device. The edge device 108, the designated criteria evaluation device and the designated responding device may be selected from one of the edge devices 108, including the edge device 108 which detects the trigger event and further edge devices 108, and the secondary server 112. Additionally, one or more of the edge device 108 which detects the trigger event, the designated criteria evaluation device and the designated responding device may be the same device. In other examples, the method 400 may be performed by other suitable systems and/or devices.

At blocks 405, the edge device 108, the designated criteria evaluation device and the designated responding device receive instructions (e.g., corresponding to the instructions sent at block 330 of the method 300) to enable execution of the function when the edge device 108 detects the trigger event. In the present example, blocks 405 are described as being performed simultaneously by the server 104 prior to detection of a trigger event by the edge device 108. In other examples, the blocks 405 may occur in real-time as the server 104 selects a designated criteria evaluation device and a designated responding device in response to detection of a trigger at the edge device 108.

In particular, at block 405-1, the edge device 108 receives trigger event processing instructions from the server 104. The trigger event processing instructions, when executed, configure the edge device 108 to prompt the designated criteria evaluation device to initiate evaluation of the criteria upon detection of the trigger event at the edge device. In particular, the trigger event processing instructions may specify the specific designated criteria evaluation device selected by the server 104, for example by specifying the IP address or other identifier of the designated criteria evaluation device. If the designated criteria evaluation device varies based on proximity to the edge device, the trigger event processing instructions may include specific instructions for execution by the edge device 108 to configure the edge device 108 to identify the appropriate designated criteria evaluation device to select. Thus, the trigger event processing instructions configure the edge device 108 to identify and prompt evaluation of the criteria at the designated criteria evaluation device selected by the server 104 (e.g., at block 320 of the method 300).

At block 405-2, the designated criteria evaluation device receives criteria evaluation instructions. The criteria evaluation instructions, when executed, configure the designated criteria evaluation device to evaluate the criteria, and when the criteria are satisfied, prompt the designated responding device to initiate generation of the response. In particular, the criteria evaluation instructions may specify the specific designated responding device selected by the server 104 (e.g., by IP address or other identifier), or may provide instructions for execution by the designated criteria evaluation device to identify the appropriate designated responding device to select. Thus, the criteria evaluation instructions configure the designated criteria evaluation device to identify and prompt generation of the response at the designated responding device selected by the server 104 (e.g., at block 325 of the method 300). The criteria evaluation instructions may be received from the server 104 directly and stored until the designated criteria evaluation device is prompted to execute the criteria evaluation instructions by the edge device 108 which detects the trigger event. Alternately, the criteria evaluation instructions may be received from the edge device 108 itself for immediate execution after detecting the trigger event at the edge device 108.

At block 405-3, the designated responding device receives response instructions from the server 104. The response instructions, when executed, configure the designated response device to generate the response. The response instructions may be received from the server 104 directly and stored until the designated responding device is prompted to execute the response instructions by the designated criteria evaluation device after satisfaction of the criteria. Alternately, the response instructions may be received from the designated criteria evaluation device for immediate execution after satisfaction of the criteria.

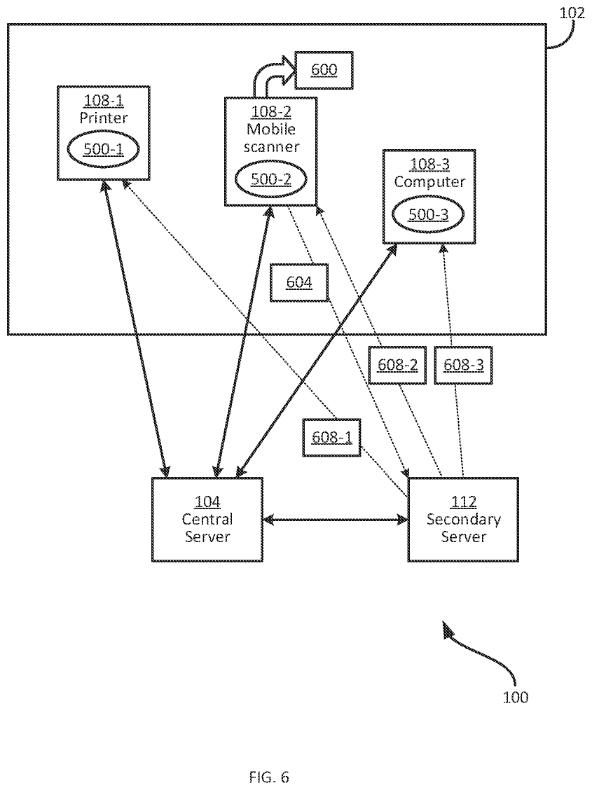

Processing of the function is initiated at block 410, wherein the edge device 108 detects a trigger event. For example, referring to FIG. 6, the mobile scanner 108-2 may detect a trigger event 600. In particular, the trigger event may be that a barcode is scanned, triggering a function to identify high-value or critical shipments in a shipping and delivery facility.

Returning to FIG. 4, at block 415, upon detection of the trigger event, the edge device 108 executes the trigger event processing instructions. Execution of the trigger event processing instructions configure the edge device 108 to prompt the designated criteria evaluation device to initiate evaluation of the criteria. In some examples, the trigger event processing instructions may first configure the edge device 108 to identify the designated criteria evaluation device (e.g., by initiating a routine to locate a nearest desktop or laptop computing device or the like).

For example, if the designated criteria evaluation device is a different device from the edge device 108, the edge device 108 may send an initiation message to the designated criteria evaluation device. The initiation message may include data pertaining to the edge device 108 itself (e.g., a device identifier) as well as data pertaining to the trigger event (e.g., a package identifier encoded into the barcode, date/time data, etc.), and other relevant data for evaluating the criteria. In some examples, the initiation message may additionally include the criteria evaluation instructions themselves (i.e., if the designated criteria evaluation device is dynamically selected and/or has otherwise not received the criteria evaluation instructions from the server 104).

If the designated criteria evaluation device is the same device as the edge device 108 which detected the trigger event, the edge device 108 may simply proceed to initiate the criteria evaluation.

At block 420, the designated criteria evaluation device receives the prompt to initiate the criteria evaluation. Upon receiving the prompt, the designated criteria evaluation device executes the criteria evaluation instructions. For example, referring again to FIG. 6, detection of the trigger 600 at the mobile scanner 108-2 may cause a prompt 604 to be sent to the secondary server 112. In some examples, the mobile scanner 108-2 may send the prompt 604 to the secondary server 112 directly, while in other examples, the prompt 604 may be routed through the central server 104.

At block 425, the designated criteria evaluation device determines whether the criteria are satisfied. For example, in the function to identify high-value or critical shipments, the criteria may be that the identified package is high-value or critical. In some examples, the criteria may include more than one condition which may be satisfied. For example, the criteria may be, in addition to identifying high-value or critical packages, differentiating between high-value packages (e.g., for which extra care is to be taken in handling) and critical packages (e.g., for which high priority or expedited shipping is to be implemented). If any of the conditions of the criteria are satisfied, the method 400 proceeds to block 430. Otherwise, the method 400 is complete. As will be appreciated, the method 400 may then be repeated at subsequent detections of the trigger event.

At block 430, the designated criteria evaluation device continues executing the criteria evaluation instructions to prompt the designated responding device to generate the response. In some examples, the criteria evaluation instructions may first configure the designated criteria evaluation device to identify the designated responding device (e.g., by initiating a routine to locate a nearest printer or the like).

For example, if the designated responding device is a different device from the designated criteria evaluation device, the designated criteria evaluation device may send an initiation message to the designated responding device. The initiation message may include data pertaining to the either or both of the edge device 108 and the designated criteria evaluation device, data pertaining to the trigger event and/or the criteria evaluation results, and other relevant data for generating the response. In some examples, the initiation message may additionally include the response instructions themselves (i.e., if the designated responding device is dynamically selected and/or has otherwise not received the response instructions from the server 104).

If the designated responding device is the same device as the designated criteria evaluation device, the designated criteria evaluation device may simply proceed to initiate generation of the response.

At block 435, the designated responding device receives the prompt to initiate the response. Upon receiving the prompt, the designated responding device executes the response instructions. For example, referring again to FIG. 6, after evaluating the criteria to be satisfied, the secondary server 112 may cause prompts 608-1, 608-2, and 608-3 to be sent to the printer 108-1, the mobile scanner 108-2, and the computer 108-3. In particular, the prompt 608-1 may prompt a label to be printed at the printer 108-1, the prompt 608-2 may prompt the mobile scanner 108-2 to vibrate, and the prompt 608-3 may prompt the computer 108-3 to display a notification message. In some examples, the secondary server 112 may send the prompts 608 to the printer 108-1, the mobile scanner 108-2, and the computer 108-3 directly, while in other examples, the prompt 604 may be routed through the central server 104.

At block 440, execution of the response instructions configures the designated responding device to generate the response. For example, in the function to identify high-value or critical shipments, the response instructions may be a print command to print a label identifying the package as high-value or critical. In some examples, the response may vary based on the condition of the criteria which was satisfied, hence the prompt may specify whether to print a high-value label or a critical shipment label. Further, in some examples, more than one designated responding device may be selected to generate different responses. In addition to printing a high-value or critical label, the edge device 108 which scanned the package (i.e., which detected the trigger event) may be selected as another designated responding device to vibrate or generate a visual alert to notify the operator that the package is high-value or critical and that an appropriate label has been printed for application to the package.

After execution of block 440, the method 400 is complete, and may be repeated for subsequent detections of trigger events at the edge device 108.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method comprising:
storing, at a central server, a function definition including: (i) a trigger event to initiate the function; (ii) criteria to be evaluated; and (iii) a response definition;
selecting, at the central server, for each of a plurality of edge devices capable of detecting the trigger event and in communication with the central server, a designated criteria evaluation device assigned to evaluate the criteria when the trigger event is detected at the edge device;
selecting, at the central server, for each of the plurality of edge devices capable of detecting the trigger event and in communication with the central server, a designated responding device assigned to generate the response when the criteria are satisfied; and
sending instructions to the edge device, the designated criteria evaluation device, and the designated responding device to enable execution of the function when the edge device detects the trigger event.

2. The method of claim 1, wherein the designated criteria evaluation device and the designated responding device are selected from one of: the edge device, a plurality of further edge devices, and a secondary server.

3. The method of claim 2, further comprising:
receiving, at the central server, device capabilities from the edge device and each of the plurality of further edge devices; and
selecting the designated criteria evaluation device and the designated responding device based on the device capabilities.

4. The method of claim 1, further comprising selecting respective designated criteria evaluation devices and designated responding devices for each further edge device capable of detecting the trigger event of the function.

5. The method of claim 1, wherein sending the instructions comprises sending trigger event processing instructions to the edge device, wherein execution of the trigger event processing instructions configures the edge device to prompt the designated criteria evaluation device to initiate evaluation of the criteria upon detection of the trigger event at the edge device.

6. The method of claim 1, wherein sending the instructions comprises sending criteria evaluation instructions to the designated criteria evaluation device, wherein execution of the criteria evaluation instructions configures the designated criteria evaluation device to:
evaluate the criteria; and
when the criteria are satisfied, prompt the designated responding device to initiate generation of the response.

7. The method of claim 1, wherein sending the instructions comprises sending response instructions to the designated responding device, wherein execution of the response instructions configures the designated responding device to generate the response.

8. The method of claim 1, further comprising:
detecting, at the edge device, the trigger event;
in response to detecting the trigger event at the edge device, evaluating the criteria at the designated criteria evaluation device; and
when the criteria are satisfied, executing generating the response at the designated responding device.

9. A server comprising:
a memory storing a function definition including: (i) a trigger event to initiate the function; (ii) criteria to be evaluated; and (iii) a response definition; and
a processor connected with the memory, the processor configured to:
select, for each of a plurality of edge devices capable of detecting the trigger event and in communication with the server, a designated criteria evaluation device assigned to evaluate the criteria when the trigger event is detected at the edge device;
select, for each of the plurality of edge devices capable of detecting the trigger event and in communication with the server, a designated responding device assigned to generate the response when the criteria are satisfied; and
send instructions to the edge device, the designated criteria evaluation device, and the designated responding device to enable execution of the function when the edge device detects the trigger event.

10. The server of claim 9, wherein the designated criteria evaluation device and the designated responding device are selected from one of: the edge device, a plurality of further edge devices, and a secondary server.

11. The server of claim 10, wherein the processor is further configured to:
obtain device capabilities of the edge device and each of the plurality of further edge devices; and
select the designated criteria evaluation device and the designated responding device based on the device capabilities.

12. The server of claim 9, wherein the processor is further configured to select respective designated criteria evaluation devices and designated responding devices for each further edge device capable of detecting the trigger event.

13. The server of claim 9, wherein to send the instructions, the processor is configured to: send trigger event processing instructions to the edge device, wherein execution of the trigger event processing instructions configures the edge device to prompt the designated criteria evaluation device to initiate evaluation of the criteria upon detection of the trigger event at the edge device.

14. The server of claim 9, wherein to send the instructions, the processor is configured to: send criteria evaluation instructions to the designated criteria evaluation device, wherein execution of the criteria evaluation instructions configures the designated criteria evaluation device to:
evaluate the criteria; and
when the criteria are satisfied, prompt the designated responding device to initiate generation of the response.

15. The server of claim 9, wherein to send the instructions, the processor is configured to: send response instructions to the designated responding device, wherein execution of the response instructions configures the designated responding device to generate the response.

16. A system comprising:
a plurality of edge devices located at a facility;
a secondary server; and
a central server configured to:
store a function definition including: (i) a trigger event to initiate the function; (ii) criteria to be evaluated; and (iii) a response definition;
select, for each of the plurality of edge devices capable of detecting the trigger event and in communication with the central server, a designated criteria evaluation device from the plurality of edge devices and the secondary server, the designated criteria evaluation device assigned to evaluate the criteria when the trigger event is detected at the selected edge device;
select, for each of the plurality of edge devices capable of detecting the trigger event and in communication with the central server, a designated responding device from the plurality of edge devices and the secondary server, the designated responding assigned to generate the response when the criteria are satisfied; and
send instructions to the edge device, the designated criteria evaluation device, and the designated responding device to enable execution of the function when the edge device detects the trigger event.

17. The system of claim 16, wherein each of the plurality of edge devices includes a runtime agent configured to determine device capabilities of the respective edge device and send the device capabilities to the central server to select the designated criteria evaluation device and the designated responding device based on the device capabilities of the respective edge devices.

18. The system of claim 16, wherein to send the instructions, the central server is configured to:
send trigger event processing instructions to the selected edge device, wherein execution of the trigger event processing instructions configures the selected edge device to prompt the designated criteria evaluation device to initiate evaluation of the criteria upon detection of the trigger event at the selected edge device;
send criteria evaluation instructions to the designated criteria evaluation device, wherein execution of the criteria evaluation instructions configures the designated criteria evaluation device to:
evaluate the criteria; and
when the criteria are satisfied, prompt the designated responding device to initiate generation of the response; and
send response instructions to the designated responding device, wherein execution of the response instructions configures the designated responding device to generate the response.

19. The system of claim 16, wherein to send the instructions, the central server is configured to:
send trigger event processing instructions to the selected edge device, the trigger event processing instructions encoding criteria evaluation instructions; and
wherein execution of the trigger event processing instructions, upon detection of the trigger event at the selected edge device, configures the selected edge device to:
propagate the criteria evaluation instructions to the designated criteria evaluation device; and
prompt the designated criteria evaluation device to initiate evaluation of the criteria.

20. The system of claim 19, wherein the criteria evaluation instructions encode response instructions; and
wherein execution of the criteria evaluation instructions configures the designated criteria evaluation device to:
evaluate the criteria; and
when the criteria are satisfied:
propagate the response instructions to the designated responding device; and
prompt the designated responding device to initiate generation of the response.
